(19) United States
(12) Patent Application Publication
(10) Pub. No.: US 2025/0005320 A1
(43) Pub. Date: Jan. 2, 2025

(54) SLICING LAYERS OF MACHINE LEARNING MODELS ACROSS DISTRIBUTED SYSTEMS

(71) Applicant: International Business Machines Corporation, Armonk, NY (US)

(72) Inventors: Sathya Santhar, Ramapuram (IN); Sridevi Kannan, Chennai (IN); Sarbajit K. Rakshit, Kolkata (IN); Suvedhahari Velusamy, Irving, TX (US)

(21) Appl. No.: 18/215,028

(22) Filed: Jun. 27, 2023

(51) Int. Cl. G06N 3/04; G06N 3/08

(52) U.S. Cl. CPC G06N 3/04; G06N 3/08

(57) ABSTRACT

A computer-implemented method, according to one embodiment, includes: processing a user request using a machine learning model having a plurality of layers. Processing the user request includes using information received at a central compute location to determine a first subset of the layers in the machine learning model, and a second subset of the layers in the machine learning model. Moreover, data corresponding to the user request is processed using the first subset of layers at an edge compute location. In response to receiving a result from the first subset of layers at the edge compute location, the result is processed using the second subset of layers at the central compute location. Furthermore, the user request is satisfied by outputting a result of the processing by the second subset of layers.

### BACKGROUND

The present invention relates to distributed systems, and more specifically, this invention relates to dividing the various layers of machine learning models across distributed systems.

One aspect of developing a system having compute capabilities (also referred to herein as a compute infrastructure) involves determining whether the system will operate under a variety of different scenarios. For instance, different combinations of system settings, user preferences, instructions received, etc., may impact system operation.

The increased amount of data collected from sensors and IoT devices has also changed how and/or where the data is actually processed. For instance, the traditional computing paradigm implementing a centralized data center is not well suited to transfer increasingly large sets of real-world data between separated locations. Bandwidth limitations, latency issues and unpredictable network disruptions can all negatively impact such efforts, leading to an unstable system that is prone to experiencing downtime.

This issue has also become more prevalent as the complexity of machine learning models increases. Increasingly complex machine learning models translate to more intense workloads and increased strain associated with applying the models to received data. The operation of conventional implementations has thereby been negatively impacted.

### SUMMARY

A computer-implemented method, according to one embodiment, includes: processing a user request using a machine learning model having a plurality of layers. Processing the user request includes using information received at a central compute location to determine a first subset of the layers in the machine learning model, and a second subset of the layers in the machine learning model. Moreover, data corresponding to the user request is processed using the first subset of layers at an edge compute location. In response to receiving a result from the first subset of layers at the edge compute location, the result is processed using the second subset of layers at the central compute location. Furthermore, the user request is satisfied by outputting a result of the processing by the second subset of layers.

A computer program product, according to another embodiment, includes a computer readable storage medium having program instructions embodied therewith. Moreover, the program instructions are readable by a processor, executable by the processor, or readable and executable by the processor, to cause the processor to: perform the foregoing method.

A system, according to yet another embodiment, includes: a processor, as well as logic that is integrated with the processor, executable by the processor, or integrated with and executable by the processor. Furthermore, the logic is configured to: perform the foregoing method.

Other aspects and embodiments of the present invention will become apparent

from the following detailed description, which, when taken in conjunction with the drawings. illustrate by way of example the principles of the invention.

### BRIEF DESCRIPTION OF THE DRAWINGS

FIG. 1 is a diagram of a computing environment, in accordance with one embodiment.

FIG. 2 is a diagram of a tiered data storage system, in accordance with one embodiment.

FIG. 3 is a diagram of a distributed system, in accordance with one embodiment.

FIG. 4A is a flowchart of a method, in accordance with one embodiment.

FIG. 4B is a flowchart of sub-operations which involve the operations in the method of FIG. 4A, in accordance with one embodiment.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for splitting implementation of the different layers in a machine learning model across different server locations. Accordingly, implementations herein are able to achieve faster and more comprehensive data analysis across a shared network model, thereby creating an opportunity for deeper insights, faster response times, improved customer experiences, greater adoption rates, etc. This is achieved by implementing dynamic network slicing of machine learning model layers across one or more edge servers and a central server, e.g., as will be described in further detail below.

In one general embodiment, a computer-implemented method includes: processing a user request using a machine learning model having a plurality of layers. Processing the user request includes using information received at a central compute location to determine a first subset of the layers in the machine learning model, and a second subset of the layers in the machine learning model. Moreover, data corresponding to the user request is processed using the first subset of layers at an edge compute location. In response to receiving a result from the first subset of layers at the edge compute location, the result is processed using the second subset of layers at the central compute location. Furthermore, the user request is satisfied by outputting a result of the processing by the second subset of layers.

In another general embodiment, a computer program product includes a computer readable storage medium having program instructions embodied therewith. Moreover, the program instructions are readable by a processor, executable by the processor, or readable and executable by the processor, to cause the processor to: perform the foregoing method.

In yet another general embodiment, a system includes: a processor, as well as logic that is integrated with the processor, executable by the processor, or integrated with and executable by the processor. Furthermore, the logic is configured to: perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved splitting code at block 150 for splitting implementation of the different layers in a machine learning model across different server locations. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

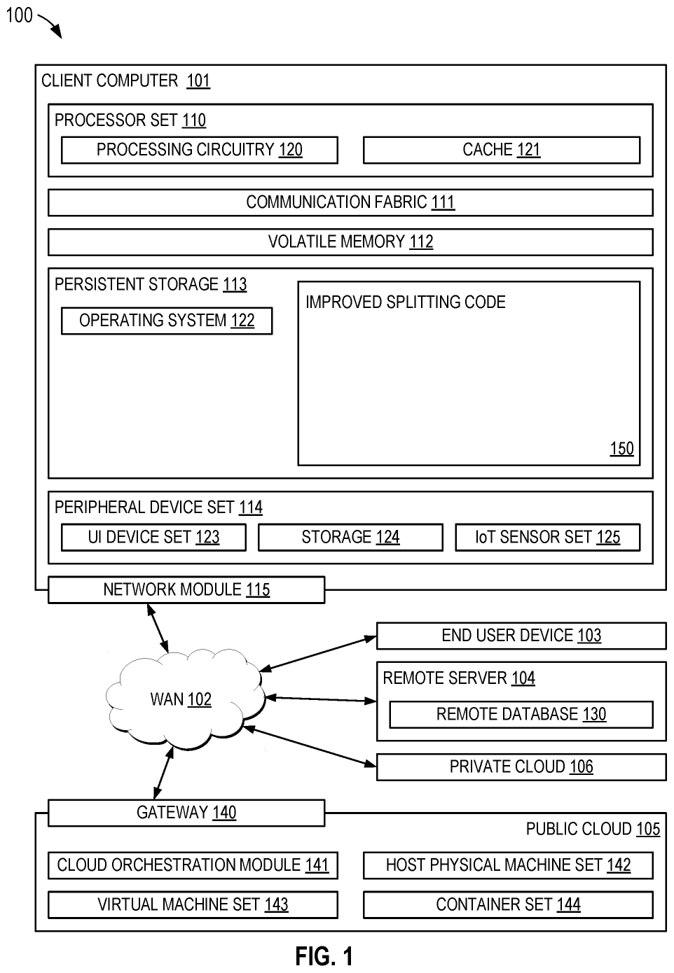

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

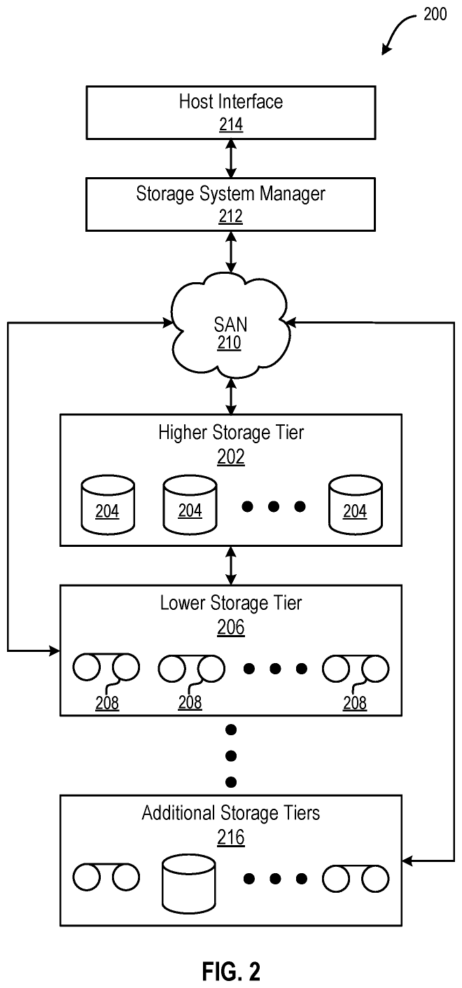

Now referring to FIG. 2, a storage system 200 is shown according to one embodiment. Note that some of the elements shown in FIG. 2 may be implemented as hardware and/or software, according to various embodiments. The storage system 200 may include a storage system manager 212 for communicating with a plurality of media and/or drives on at least one higher storage tier 202 and at least one lower storage tier 206. The higher storage tier(s) 202 preferably may include one or more random access and/or direct access media 204, such as hard disks in hard disk drives (HDDs), nonvolatile memory (NVM), solid state memory in solid state drives (SSDs), flash memory, SSD arrays, flash memory arrays, etc., and/or others noted herein or known in the art. The lower storage tier(s) 206 may preferably include one or more lower performing storage media 208, including sequential access media such as magnetic tape in tape drives and/or optical media, slower accessing HDDs, slower accessing SSDs, etc., and/or others noted herein or known in the art. One or more additional storage tiers 216 may include any combination of storage memory media as desired by a designer of the system 200. Also, any of the higher storage tiers 202 and/or the lower storage tiers 206 may include some combination of storage devices and/or storage media.

The storage system manager 212 may communicate with the drives and/or storage media 204, 208 on the higher storage tier(s) 202 and lower storage tier(s) 206 through a network 210, such as a storage area network (SAN), as shown in FIG. 2, or some other suitable network type. The storage system manager 212 may also communicate with one or more host systems (not shown) through a host interface 214, which may or may not be a part of the storage system manager 212. The storage system manager 212 and/or any other component of the storage system 200 may be implemented in hardware and/or software, and may make use of a processor (not shown) for executing commands of a type known in the art, such as a central processing unit (CPU), a field programmable gate array (FPGA), an application specific integrated circuit (ASIC), etc. Of course, any arrangement of a storage system may be used, as will be apparent to those of skill in the art upon reading the present description.

In more embodiments, the storage system 200 may include any number of data storage tiers, and may include the same or different storage memory media within each storage tier. For example, each data storage tier may include the same type of storage memory media, such as HDDs, SSDs, sequential access media (tape in tape drives, optical disc in optical disc drives, etc.), direct access media (CD-ROM, DVD-ROM, etc.), or any combination of media storage types. In one such configuration, a higher storage tier 202, may include a majority of SSD storage media for storing data in a higher performing storage environment, and remaining storage tiers, including lower storage tier 206 and additional storage tiers 216 may include any combination of SSDs, HDDs, tape drives, etc., for storing data in a lower performing storage environment. In this way, more frequently accessed data, data having a higher priority, data needing to be accessed more quickly, etc., may be stored to the higher storage tier 202, while data not having one of these attributes may be stored to the additional storage tiers 216, including lower storage tier 206. Of course, one of skill in the art, upon reading the present descriptions, may devise many other combinations of storage media types to implement into different storage schemes, according to the embodiments presented herein.

According to some embodiments, the storage system (such as 200) may include logic configured to receive a request to open a data set, logic configured to determine if the requested data set is stored to a lower storage tier 206 of a tiered data storage system 200 in multiple associated portions, logic configured to move each associated portion of the requested data set to a higher storage tier 202 of the tiered data storage system 200, and logic configured to assemble the requested data set on the higher storage tier 202 of the tiered data storage system 200 from the associated portions.

As previously mentioned, the increase of data collected from sensors and IoT devices over time has changed how and/or where the data is actually processed. For instance, the traditional computing paradigm implementing a centralized data center is not well suited to transfer increasingly large sets of real-world data. Bandwidth limitations, latency issues and unpredictable network disruptions can all negatively impact such efforts.

Some implementations herein overcome these conventional shortcomings by implementing distributed compute architectures that incorporate edge computing. As noted above, edge computing involves a distributed IT architecture in which data is processed closer to the originating source of the data rather than a centralized location. This reduces the amount of data that is transferred between locations by a network, thereby lowering network traffic and significantly reducing latency.

It follows that edge computing transitions at least a portion of data storage and compute resources away from a central location and closer to the source of the data itself. As a result, rather than transmitting raw data to a central data center for processing and analysis, computational work is performed on the data before it is sent over a network to a different location. Thereafter, a result of performing the edge computing can be sent to the central data center much more efficiently than the raw data could be.

Accordingly, implementations herein are able to split various processes between a central server (also referred to herein as a “main server”) and one or more edge servers. Doing so allows for at least some computations to be performed at the edge servers, while remaining computations are performed in the main server. This reduces the amount of data that is ultimately transferred between servers (e.g., network locations), thereby reducing network traffic and further improving performance of the system as a whole, e.g., as will be described in further detail below.

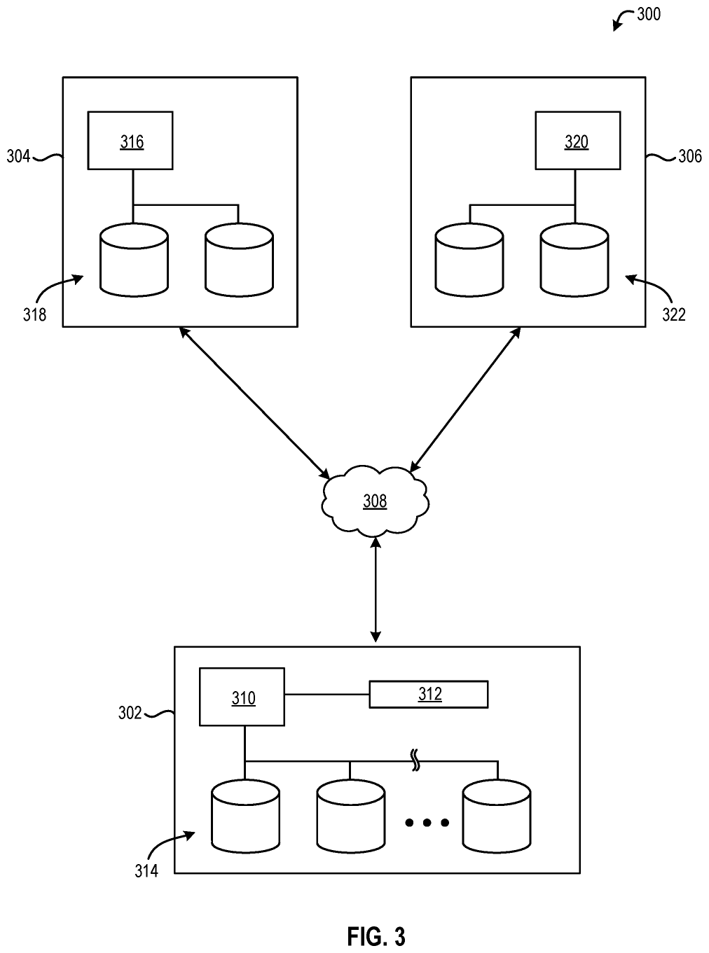

Looking now to FIG. 3, a system 300, having a distributed compute architecture in accordance with one embodiment. As an option, the present system 300 may be implemented in conjunction with features from any other embodiment listed herein, such as those described with reference to the other FIGS., such as FIG. 1. However, such system 300 and others presented herein may be used in various applications and/or in permutations which may or may not be specifically described in the illustrative embodiments listed herein. Further, the system 300 presented herein may be used in any desired environment. Thus FIG. 3 (and the other FIGS.) may be deemed to include any possible permutation.

As shown, the system 300 includes a central compute location 302 that is connected to a first edge compute location 304 and a second edge compute location 306. Specifically, the central compute location 302, first edge compute location 304, and second edge compute location 306 are each connected to a network 308. As a result, any desired information, data, commands, instructions, responses, requests, etc. may be sent between any two or more of the locations 302, 304, 306.

The network 308 may be of any type, e.g., depending on the desired approach. For instance, in some approaches the network 308 is a WAN, e.g., such as the Internet. However, an illustrative list of other network types which network 308 may implement includes, but is not limited to, a LAN, a PSTN, a SAN, an internal telephone network, etc. Accordingly, any two or more of the locations 302, 304, 306 are able to communicate with each other regardless of the amount of separation which exists therebetween, e.g., despite being positioned at different geographical locations.

It should also be noted that two or more of the locations 302, 304, 306 may be connected differently depending on the approach. According to an example, two edge compute locations may be located relatively close to each other and connected by a wired connection, e.g., a cable, a fiber-optic link, a wire, etc., or any other type of connection which would be apparent to one skilled in the art after reading the present description.

With continued reference to FIG. 3, each of the locations 302, 304, 306 may also have a different configuration depending on the approach. For example, central compute location 302 includes a large (e.g., robust) processor 310 coupled to a cache 312 and a data storage array 314 having a relatively high storage capacity. The central compute location 302 is thereby able to process and store a relatively large amount of data, allowing it to be connected to, and manage, multiple different remote edge locations. As noted above, the central compute location 302 may receive data, commands, etc. from any number of locations. The components included in the central compute location 302 thereby preferably have a higher achievable throughput than components included in each of the edge compute locations 304, 306, to accommodate the higher flow of data experienced at the central compute location 302.

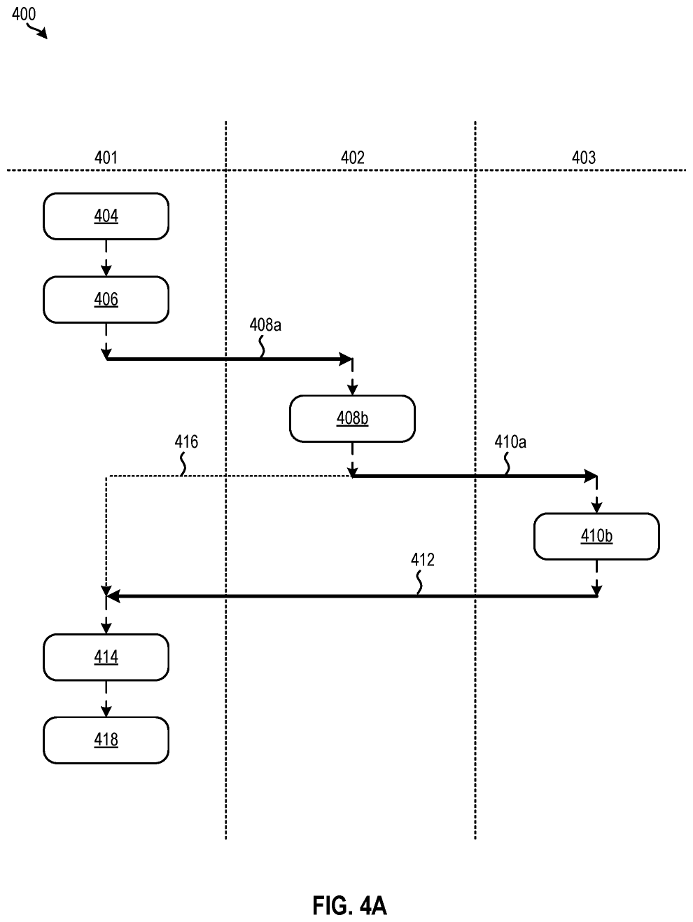

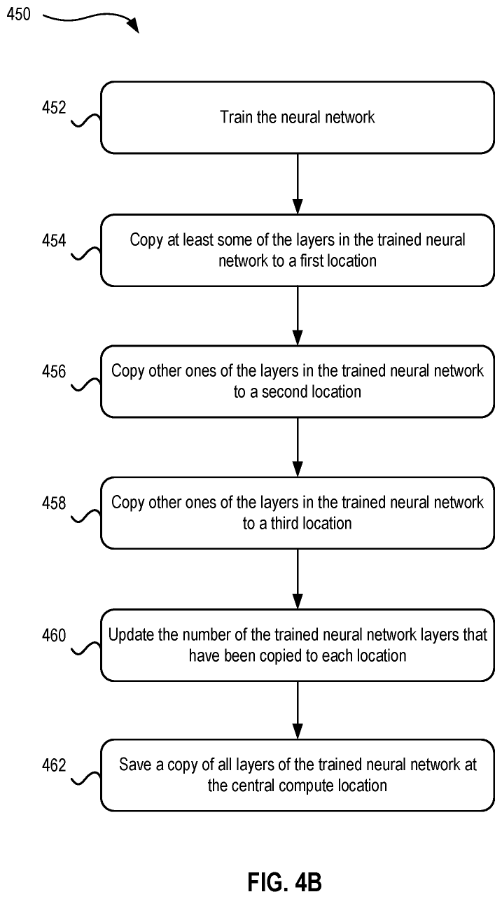

It should be noted that with respect to the present description, “data” may include any desired type of information. For instance, in different implementations data can include raw sensor data, metadata, program commands, instructions, etc. It follows that the processor 310 may use the cache 312 and/or storage array 314 to actually cause one or more data operations to be performed. According to an example, the processor 310 at the central compute location 302 may be used to perform one or more operations of method 400 of FIG. 4A, e.g., as will be described in further detail below.

With continued reference to FIG. 3, edge compute location 304 includes a processor 316 coupled to memory 318. Similarly, edge compute location 306 includes a processor 320 coupled to memory 322. While the edge compute locations 304, 306 are depicted as including similar components and/or construction, it should be noted that any desired components may be implemented in any desired arrangement. In some instances, each edge compute location in a system may be configured differently to provide each location with a different ability. According to an example, which is in no way intended to limit the invention, edge compute location 304 may include a cryptographic module (not shown) that allows the edge compute location 304 to produce encrypted data, while edge compute location 306 includes a data compression module (not shown) that allows the edge compute location 306 to produce compressed data.

It follows that the different compute locations (e.g., servers) in system 300 may have different performance capabilities. As noted above, the central compute location 302 may have a higher achievable throughput compared to the edge compute locations 304, 306. While this may allow the central compute location 302 the ability to perform more data operations in a given amount of time than the edge compute locations 304, 306, other factors impact achievable performance. For example, traffic over network 308 may limit the amount of data that may be sent between the different locations 302, 304, 306. The workload experienced at a given time also impacts latency and limits achievable performance.

These varying performance characteristics have a material impact on the efficiency by which the system can operate as well as how efficiency can be improved. For example, it may be more efficient to process data at the lower throughput edge compute locations 304, 306 during times of high traffic on network 308, while it is more efficient to process a majority of data at the central compute location 302 when traffic on network 308 is low.

Thus, by monitoring and reacting to changing bandwidth limitations, high-quality real-time media streaming, excess latency, network congestion, etc., implementations herein are able to dynamically update settings of the system to maintain a relatively high level of efficiency.

Similarly, things like shared network models can be implemented (e.g., stored) across edge compute locations and central compute locations. This allows for the shared model to be implemented across a distributed system. Moreover, by tracking dynamic characteristics as they change over time, adjustments may be made in real-time to how and/or where certain portions of a model are used to maintain improved access times for specific content requested. In other words, different portions of a model (e.g., such as a machine learning model) may be stored at and/or used at different locations in a distributed system based on a complex combination of real-time operating settings.

Providing network slicing functionality between edge compute locations and a central compute location thereby improves performance. Looking now to FIG. 4, a method 400 for splitting implementation of the different layers in a machine learning model across different server locations is illustrated in accordance with one embodiment.

The method 400 may be performed in accordance with the present invention in any of the environments depicted in FIGS. 1-3, among others, in various embodiments. Of course, more or less operations than those specifically described in FIG. 4 may be included in method 400, as would be understood by one of skill in the art upon reading the present descriptions.

Each of the steps of the method 400 may be performed by any suitable component of the operating environment. For example, each of the nodes 401, 402, 403 shown in the flowchart of method 400 may correspond to one or more processors positioned at a different location in a multi-tiered data storage system. Moreover, each of the one or more processors are preferably configured to communicate with each other.

In various embodiments, the method 400 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 400. Illustrative processors include, but are not limited to, a central processing unit (CPU), an application specific integrated circuit (ASIC), a field programmable gate array (FPGA), etc., combinations thereof, or any other suitable computing device known in the art.

As mentioned above, FIG. 4 includes different nodes 401, 402, 403, each of which represent one or more processors, controllers, computer, etc., positioned at a different location in a distributed data storage system. For instance, node 401 may include one or more processors located at a central compute location (e.g., main server) of a distributed compute system (e.g., see processor 310 of FIG. 3 above). Node 402 may include one or more processors located at a first edge compute location (e.g., edge server) of a distributed compute system (e.g., see processor 316 of FIG. 3 above). Furthermore, node 403 may include one or more processors located at a second edge compute location of a distributed compute system (e.g., see processor 320 of FIG. 3 above). Accordingly, commands, data, requests, etc. may be sent between each of the nodes 401, 402, 403 depending on the approach. Moreover, it should be noted that the various processes included in method 400 are in no way intended to be limiting, e.g., as would be appreciated by one skilled in the art after reading the present description. For instance, data sent from node 402 to node 403 may be prefaced by a request sent from node 403 to node 402 in some approaches.

Looking to FIG. 4, method 400 includes operation 404. There, operation 404 involves receiving a user request. The type of request received at operation 404 may vary depending on the particular implementation. For instance, the request may be received from different users, running applications, remote systems, etc. In one example, the user request may be received at an edge server from the user's computer (e.g., laptop) which is in communication with the edge server.

While some user requests like read requests may be solved by simply accessing data in memory, other user requests are more complicated to satisfy. As noted above, some user requests involve evaluating data using the various layers of a machine learning model. While data may be evaluated by each of these layers using a same processor, the achievable throughput of the processor becomes a limiting factor. Processors also have different capabilities depending on design, age (i.e., manufacture date), etc. Thus, to increase throughput, layers may be divided across more than one processor, such that portions of the machine learning model are implemented by different processors. With respect to the present description, a machine learning model layer may be “implemented” by a processor in the sense that the processor may use the machine learning model layer to process data. In other words, the processor may be configured to apply the machine learning model layer to input data and produce an output.

Moreover, the request may involve data already stored in a system, processing newly received data, etc. The user request may also be received from a number of different locations. For example, in some instances the user is located at an edge compute location of a distributed compute system. In this example, it may be desirable for certain layers of a machine learning model to be implemented at the edge compute location, e.g., to avoid sending large amounts of data over a network connecting the edge compute location to a remainder of the distributed compute system.

As noted above, the process of determining how the various layers of a machine learning model are divided among two or more different processors is a complicated task that may be performed with varied success. For example, layers of a machine learning model can be evenly divided across three processors, but if the processors have different operational throughputs, the machine learning model will be performed less efficiently than if the difference in operational throughput was taken into account.

Method 400 is thereby able improve the operational efficiency of systems by processing a user request using a machine learning model having a plurality of layers that are divided across two or more processors in a manner that incorporates characteristics of the processors, one or more networks connecting the processors, etc. By incorporating these characteristics, the machine learning model can be used to satisfy a user request in less time than previously achievable. Implementations herein thereby effectively increase the achievable throughput of the system and lower latency.

Accordingly, operation 406 includes using information representing characteristics of a distributed data storage system to determine first, second, and third subsets of the layers in the machine learning model. In other words, operation 406 includes using information that describes various performance based details (e.g., throughput characteristics) of the processors at each of nodes 401, 402, 403; the network(s) connecting each of nodes 401, 402, 403; etc., to identify a preferred separation of the layers in a machine learning model across the nodes 401, 402, 403.

The type of information used in operation 406 may vary and can include past performance metrics, predicted loads, readings received from sensors, current operating settings of various components, network performance metrics, etc. In preferred approaches, this information is received at node 401 in real-time as a steady stream. Accordingly, the information can be used to determine the first, second, and third subsets of layers in real-time as the information is received. This desirably allows for changes in performance to be taken into account as they occur, thereby improving efficiency of the system by dynamically adjusting where and how the various layers of a machine learning model are implemented, in real-time.

However, in other approaches the data may be received at node 401 (e.g., the central compute location) periodically in packets, in response to a predetermined condition being met, etc. For example, performance based details may be received in response to a user request being received, thereby minimizing impact to network traffic. Moreover, the information may be received from nodes 402, 403 and/or other locations, e.g., such as a network management node.

It follows that the respective sizes of the first, second, and third subsets of layers vary depending on the implementation. In response to determining the first, second, and third subsets of layers in operation 406, the first subset of layers are implemented at node 402. Accordingly, operation 408a includes sending one or more instructions to node 402 (e.g., an edge compute location). The one or more instructions are thereby received and implemented by a processor at node 402. See operation 408b. As a result, the first subset of layers have been used to evaluate data at the edge compute location of node 402.

The result(s) produced by the first subset of machine learning model layers at node 402 are sent directly to node 403. See operation 410a. Other information may be sent along with the result(s) produced. For example, at least some of the instructions received at node 402 from central node 401 may be sent along to node 403 for implementation. The instructions sent may cause node 403 to use the second subset of the machine learning model layers to evaluate the result produced by the first subset of machine learning model layers at node 402. The one or more instructions are thereby received and implemented by a processor at node 403. See operation 410b. Accordingly, the result received at operation 410a is evaluated using the second subset of layers at the edge compute location of node 403.

It should be noted that the result(s) of evaluating data corresponding to the received user request using the first subset of machine learning model layers at node 402 are preferably evaluated using the second subset of machine learning model layers. Data is typically processed by machine learning model layers in a specific sequence, thereby causing each layer to incorporate the results of the previous layers. Accordingly, a result of performing operation 408b is used, at least as a partial input for operation 410b, e.g., as would be appreciated by one skilled in the art after reading the present description.

According to an example, one or more vectors are produced by a final layer of the first subset of machine learning model layers implemented at node 402, and are received at node 403. Moreover, these vectors are used as inputs for an initial layer of the second subset of layers implemented at node 403.

An application programming interface (API) may be used to collect the vector output of a given layer in the machine learning model, and use the vector as an input for a next slice. This process may be further improved by using pre-determined input and output shapes at each slice between the edge servers and the central (e.g., cloud) server. The API may thereby be used to accomplish a smooth transition of data between the machine learning layers implemented at an edge server and the layers implemented at a central server. However, this is in no way intended to be limiting and, in some implementations, at least a portion of the second set of layers may evaluate received information without implementing (e.g., relying) on results received from the first set of layers.

From operation 410b, method 400 proceeds to operation 412 where a result from the second subset of machine learning model layers are returned to the central compute location at node 401. In response to the result from the second subset of layers being received at the central compute location, operation 414 includes causing the result to be evaluated using the third subset of layers. As shown, this is implemented at node 401. As noted above, the process of implementing the third set of machine learning model layers may depend on results of implementing the first and/or second set(s) of machine learning model layers. Accordingly, the processor at node 401 may implement any of the information (e.g., vectors) received from node 403, including information associated with operations performed at node 402. In some cases, information (e.g., vectors) may be received at node 401 directly from node 402, as represented by dashed line 416.

Operation 418 further includes satisfying the user request by outputting a result received from the third subset of layers. In other words, operation 418 includes outputting vectors produced by a final layer of the third subset. In some approaches, the vectors may be further processed (e.g., combined) to produce a desired format, e.g., as specified in the initially received user request. For example, a number of in-use examples are provided below which describe different ways that the results of evaluating data using machine learning model layers may be used to produce a desired result, any one or more of which may be used to perform operation 418.

Method 400 is thereby able improve the operational efficiency of systems by processing a user request using a machine learning model having a plurality of layers that are divided across two or more processors in a manner that incorporates characteristics of the processors, one or more networks connecting the processors, etc. By incorporating these characteristics, the machine learning model can be used to satisfy a user request in less time than previously achievable. Implementations herein thereby effectively increase the achievable throughput of the system and lower latency.

It should also be noted that while the different portions of machine learning model layers are located and/or implemented at specific ones of the nodes 401, 402, 403 in method 400, this is in no way intended to be limiting. Rather, any number of machine learning model layers may be implemented at any node in any desired sequence, e.g., depending on performance characteristics, e.g., as would be appreciated by one skilled in the art after reading the present description.

As noted above, the type of machine learning model implemented may vary depending on the implementation. According to an in-use example, which is in no way intended to limit the invention, the machine learning model may be a neural network. Looking to FIG. 4B, a method 450 for enabling each of the nodes 401, 402, 403 in FIG. 4A (or similarly compute locations 302, 304, 306 of FIG. 3) to perform their respective portions of the machine learning model layers is shown, according to one embodiment. While method 450 is described in the context of the machine learning model being a neural network, any type of machine learning model may be similarly implemented. Moreover, the method 450 may be performed in accordance with the present invention in any of the environments depicted in FIGS. 1-4A, among others, in various embodiments. Of course, more or less operations than those specifically described in FIG. 4B may be included in method 450, as would be understood by one of skill in the art upon reading the present descriptions.

Each of the steps of the method 450 may be performed by any suitable component of the operating environment using known techniques and/or techniques that would become readily apparent to one skilled in the art upon reading the present disclosure. For example, in various embodiments, the method 450 may be partially or entirely performed by a controller, a processor, etc., or some other device having one or more processors therein. The processor, e.g., processing circuit(s), chip(s), and/or module(s) implemented in hardware and/or software, and preferably having at least one hardware component may be utilized in any device to perform one or more steps of the method 450. Illustrative processors include, but are not limited to, a central processing unit (CPU), an application specific integrated circuit (ASIC), a field programmable gate array (FPGA), etc., combinations thereof, or any other suitable computing device known in the art.

As shown in FIG. 4B, operation 452 of method 450 includes training the neural network. In some implementations, the neural network is trained using labeled training data, while in other implementations unlabeled training data is used. In some implementations, the neural network is trained using transfer learning processes. Accordingly, the neural network may be developed and reused as a starting point for a model on a second task. In other words, the initial model may be re-purposed on a second related task. This allows the neural network to exploit the knowledge gained from a previous iterations to improve generalization about new iterations. For example, in training a classifier to predict whether an image contains food, the knowledge it gained during training to recognize drinks may be utilized (e.g., repurposed) to successfully recognize food.

According to another example, the machine learning model may be a Convolutional Neural Network (CNN). Thus, the machine learning model may be applied in some implementations as a deep learning algorithm which can take an input image, assign importance (e.g., learnable weights, biases, etc.) to various aspects and/or objects in the image, and differentiate one image from another. CNNs may be trained using a deeper model which allows for a more detailed convolution of input data. Performing a convolution on an input involves extracting a relevant feature, e.g., such as edges, shapes, colors, etc. present in the input. Thus, allowing the CNN to perform more convolutions allows the model to extract features from the dataset, thereby increasing the accuracy (e.g., precision) of the model when evaluating new data.

It follows that the neural network may be trained differently depending on the implementation. In some instances, the neural network may be pre-trained, thereby effectively obviating operation 452. In such instances, method 450 may begin at operation 454.

There, operation 454 includes copying at least some of the layers in the trained neural network to a first location. Similarly, operation 456 includes copying other ones of the layers in the trained neural network to a second location, while operation 458 includes copying still other ones of the layers in the trained neural network to a third location. Copying a machine learning model layer to a given location enables that data to be evaluated by that layer at the given location. As noted above, “implementing” a layer of a machine learning model may involve using information (e.g., vectors) received as an input for the layer, processing the information according to the configuration of the layer, and producing an output. For instance, a machine learning model layer may include a container that receives a weighted input, transforms the input using a set of functions (e.g., non-linear functions), passing the results of the functions as outputs in a result presented to the next layer. In such approaches, the ability to apply one or more functions to the input received from a previous layer of the machine learning model enables the corresponding location the ability to implement a given layer of the machine learning model.

As noted above, the portion of the machine learning model used at each available location varies depending on a number of factors. Accordingly, a number of layers copied to each location is preferably able to accommodate a portion of the machine learning model that are expected to, or at least could potentially, be performed at the respective location.

In some implementations, a subset of the machine learning model layers are copied to each compute location (e.g., server). This subset of layers common to each location may include an initial set of the layers in the machine learning model. It follows that each location may be able to perform at least a portion of the processing of the machine learning model locally. This allows for an initial classification to be made at the location a user request is initiated, before being divided across a remainder of the distributed compute system for implementation. Approaches herein are thereby able to significantly improve performance in real-time. For instance, latency is reduced a notable amount by enabling each location the ability to process an initial portion of a request received in real-time before it reaches out to other locations over one or more networks to complete the request, e.g., as would be appreciated by one skilled in the art after reading the present description.

Moreover, task specific layers may be stored at a central location/server (e.g., see central compute location 302 of FIG. 3). These task specific layers can include the intermediate layers of the machine learning model which may be further divided depending on the approach. It follows that because an initial portion of the machine learning model is already processed at the edge location/server, only the output activation units (e.g., vectors) of the layers at the edge location/server are sent as an input to the central location. This significantly reduces network traffic, as the output activation units are typically much smaller in size (amount of data) and/or complexity than an initial user request.

Further still, upon evaluating information using the task specific layers at the central location/server, results may be returned to edge location/server. Again, the results sent from the central location/server place much less strain on a network in comparison to all the data associated with the initial user request. In some approaches, an additional portion of the machine learning model layers may be performed at the edge location/server before the user request has been satisfied. In other approaches, the results received from the central location/server may be combined with other information, inspected, reorganized, converted to a different form (e.g., a different user-friendly format), etc. Thus, the user request is satisfied without having to rely solely on the processing power of the edge location/server, while also not contributing a significant amount of network traffic.

It follows that the number of layers copied to a given location may be adjusted based on past performance, predicted workloads, current workloads, network traffic, etc., and are preferably able to satisfy at least a majority of requests (e.g., see operations 408a, 408b, 410a, and 410b of FIG. 4A). Moreover, certain locations may have overlapping ones of the layers. This allows for different configurations of layers to be implemented across the locations in real-time without having to transfer any additional information between the different locations.

However, in some situations the number of the trained neural network layers that have been copied to each location may be updated (e.g., adjusted). See optional operation 460. For example, the number of layers assigned to a given location may deviate from a nominal value as a result of a higher workload. Accordingly, the number of layers stored at the location may be increased relative to other locations. This adjustment may also be based at least in part on results of previously processed user requests.

Referring still to FIG. 4B, optional operation 462 includes saving a copy of all layers of the trained neural network at the central compute location. This ensures that a backup copy of the neural network layers is maintained despite experiencing errors at edge compute locations. However, memory capacity may be limited at the central compute location in some implementations, and therefore only portions of the neural network layers may be stored.

It follows that implementations herein are able to achieve faster and more comprehensive data analysis across a shared network model, thereby creating an opportunity for deeper insights, faster response times, improved customer experiences, greater adoption rates, etc. This is achieved by implementing network slicing of machine learning model layers across one or more edge servers and a central server. Adjusting the information stored at each server using any of the implementations herein improves the efficiency by which user requests are satisfied. As noted above, this is accomplished, at least in part, by slicing network functionality across different locations (also referred to herein as servers), thereby distributing the compute load as well as the content storage. In other words, implementations herein improve performance by balancing edge computing storage techniques with the network slicing information in real-time. Moreover, a scheme for storing the different machine learning model layers across the different locations is based on this weighing of factors to maintain improved efficiency for the system (e.g., reducing network traffic, decreasing latency, etc.).

According to a specific example, which is in no way intended to limit the invention, implementations herein may be applied to a content delivery network (CDN) process. As previously mentioned, copies of common network layers initially sourced from the main server may be stored at a temporary storage location (e.g., in cache) at the edge servers. In response to performing a first portion of the request at an edge server, the result can be streamed back from the central server more efficiently in real-time.

As a result, implementations herein are able to achieve a composite model of network slicing. The common layers of a trained neural network content are placed at the edge servers, and the specific layers corresponding to the classification or identification task(s) are located at the main (central) server. Again, this allows for a user input to be partially executed at the edge server and the output of the activation layers would be passed as vectors to the specific layers maintained in the edge server. How the various layers are divided across the different locations, and the order in which results are passed therebetween also varies dynamically based on the computing power of the edge servers, predicted loads, bandwidth, etc., as they change in real-time. Moreover, the slices of a machine learning model may be executed in a sequence that allows edge servers to execute slices in increasing order, and outputs are derived from different slices based on the training that the whole model went through for different classification use cases.

According to an in-use example, which is in no way intended to be limiting, a deep neural network having 200 layers may be implemented across a distributed system. The 200 layers may include several intermediate hidden layers sliced at regular layers to predict a classification task (e.g., such as large objects, human faces, locations, etc.) at a level by performing the operations of the respective layers. In some approaches, the classification task is performed at intermediate hidden layers to predict features that are used in training of the model. However, it is undesirable that this kind of deep neural network is incorporated and trained solely on one of the edge servers, as doing so may lead to more computational expenses and inefficiency of the servers.

Rather, the 200 layers may be divided among the different servers in an arrangement that incorporates the various performance characteristics of the servers as well as the network(s) connecting them. For instance, of the 200 layers, the first 80 layers may be considered common layers, while the remaining layers are considered task specific layers. Layer 101 may be sliced to classify the objects in an image, while layer 141 is sliced to classify the human faces in an image. Furthermore, layer 191 may be sliced to classify the location shown in an image.

In a first implementation, each of the common layers (i.e., layers 1 to 80) are stored in a first edge server and the rest of the sliced classification task specific layers (i.e., layers 81 to 200) are stored in a central cloud server. Accordingly, a complete image or frame may be sent as an input to the edge server, along with a request to classify the object, human face, location, etc., in the image. Accordingly, the processing by layers 1 through 80 of a machine learning model may be performed at the edge server to perform an initial processing of the received request. As a result, only the activation units of the common layers are sent as an output from the edge server and used as an input to the central server for the classification task specific layers.

In another implementation, the common layers (i.e., layers 1 to 80) are stored in an edge server, along with some of the task specific layers. For instance, layers 81 to 101 may be stored at the edge server along with layers 1 to 80. A remainder of the task specific layers (here layers 102 to 191) are also stored at the central server. Again, if a complete image or frame is sent as an input to the edge server along with a request, processing by layers 1 through 101 of the machine learning model may be performed at the edge server. This allows for an initial portion of the received request to be processed at the edge server. In some instances, the task specific layers used at the edge server may actually satisfy the user request directly, thereby obviating the process of sending information to the central server. This further improves performance by satisfying the user request locally in situations where the user request does not involve a particularly intensive workload. Additionally, only the activation units of the common layers are sent as an output from the edge server and used as an input to the central server for the classification task specific layers located at the central server.

In yet another implementation, common layers (here layers 1 to 80) are split such that a different portion is stored in each of edge server 1 and edge server 2. For instance, the common layers may be divided across the edge servers evenly in some approaches. Accordingly, layers 1 to 40 may be stored in edge server 1, while layers 41 to 80 are stored in edge server 2. The remainder of the classification task specific layers (i.e., layers 81 to 200) are further stored in the central server. As a result, an initial portion of the user request is satisfied at edge server 1 in response to receiving the user request. The result is thereafter sent from edge server 1 to edge server 2, the result output from edge server 1 thereby serving as an input for edge server 2. The result output from edge server 2 may thereafter be transferred to the central server and used as input(s) for the task specific layers stored there.

As noted above, implementations herein may use an API to collect the outputs (e.g., vectors) of a layer that are to be used as an input for a subsequent layer of a machine learning model. Accordingly, the API can accomplish a seamless transition of data between the layers in edge servers and the central server. The definition of the parameters to be passed between servers is made generic in the API so that it can accommodate all tensors of different sizes based on the size of the output layer of each server.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
processing a user request using a machine learning model having a plurality of layers, by:
using information received at a central compute location to determine a first subset of the layers in the machine learning model, and a second subset of the layers in the machine learning model;
causing data corresponding to the user request to be processed using the first subset of layers at an edge compute location;
in response to receiving a result from the first subset of layers at the edge compute location, causing the result to be processed using the second subset of layers at the central compute location; and
satisfying the user request by outputting a result of the processing by the second subset of layers.

2. The computer-implemented method of claim 1, wherein the machine learning model is a neural network.

3. The computer-implemented method of claim 2, comprising:
training the neural network using labeled training data; and
copying at least some of the layers in the trained neural network to the edge compute location,
wherein the layers in the trained neural network copied to the edge compute location include at least the first subset of layers.

4. The computer-implemented method of claim 3, comprising:
adjusting a number of the trained neural network layers that have been copied to the edge compute location based at least in part on a previously processed user request.

5. The computer-implemented method of claim 1, wherein processing the result using the second subset of layers at the central compute location includes:
receiving one or more vectors from a final layer of the first subset of layers at the edge compute location; and
inputting the received one or more vectors in an initial layer of the second subset of layers.

6. The computer-implemented method of claim 1, wherein the information is used to determine the first and second subsets of layers in real-time as the information is received at the central compute location.

7. The computer-implemented method of claim 1, wherein the edge compute location is connected to the central compute location by a network, wherein the received information includes performance characteristics of the network.

8. The computer-implemented method of claim 7, wherein the received information includes throughput characteristics of the edge compute location.

9. The computer-implemented method of claim 1, wherein the user request is received from a computer in communication with the edge compute location.

10. The computer-implemented method of claim 1, wherein processing the user request using the machine learning model includes:
using the received information to determine a third subset of the layers in the machine learning model;
in response to the result from the first subset of layers being received at a secondary edge compute location, causing the result from the first subset of layers to be processed using the third subset of layers at the secondary edge compute location; and
in response to a result from the third subset of layers being received at the central compute location, causing the result from the third subset of layers to be processed using the second subset of layers at the central compute location.

11. A computer program product, comprising a computer readable storage medium having program instructions embodied therewith, the program instructions readable by a processor, executable by the processor, or readable and executable by the processor, to cause the processor to:
process a user request using a machine learning model having a plurality of layers, by:
using information received at a central compute location to determine a first subset of the layers in the machine learning model, and a second subset of the layers in the machine learning model;
causing data corresponding to the user request to be processed using the first subset of layers at an edge compute location;
in response to receiving a result from the first subset of layers at the edge compute location, causing the result to be processed using the second subset of layers at the central compute location; and
satisfying the user request by outputting a result of the processing by the second subset of layers.

12. The computer program product of claim 11, wherein the machine learning model is a neural network.

13. The computer program product of claim 12, wherein the program instructions are readable and/or executable by the processor to cause the processor to:
train the neural network using labeled training data; and
copy at least some of the layers in the trained neural network to the edge compute location,
wherein the layers in the trained neural network copied to the edge compute location include at least the first subset of layers.

14. The computer program product of claim 13, wherein the program instructions are readable and/or executable by the processor to cause the processor to:
adjust a number of the trained neural network layers that have been copied to the edge compute location based at least in part on a previously processed user request.

15. The computer program product of claim 11, wherein processing the result using the second subset of layers at the central compute location includes:
receiving one or more vectors from a final layer of the first subset of layers at the edge compute location; and
inputting the received one or more vectors in an initial layer of the second subset of layers.

16. The computer program product of claim 11, wherein the information is used to determine the first and second subsets of layers in real-time as the information is received at the central compute location.

17. The computer program product of claim 11, wherein the edge compute location is connected to the central compute location by a network, wherein the received information includes performance characteristics of the network, and throughput characteristics of the edge compute location.

18. The computer program product of claim 11, wherein processing the user request using the machine learning model includes:
using the received information to determine a third subset of the layers in the machine learning model;
in response to a result from the first subset of layers being received at a secondary edge compute location, causing the result from the first subset of layers to be processed using the third subset of layers at the secondary edge compute location; and
in response to a result from the third subset of layers being received at the central compute location, causing the result from the third subset of layers to be processed using the second subset of layers at the central compute location.

19. A system, comprising:
a processor; and
logic integrated with the processor, executable by the processor, or integrated with and executable by the processor, the logic being configured to:
process a user request using a machine learning model having a plurality of layers, by:
using information received at a central compute location to determine a first subset of the layers in the machine learning model, and a second subset of the layers in the machine learning model;
causing data corresponding to the user request to be processed using the first subset of layers at an edge compute location;
in response to receiving a result from the first subset of layers at the edge compute location, causing the result to be processed using the second subset of layers at the central compute location; and
satisfying the user request by outputting a result of the processing by the second subset of layers.

20. The system of claim 19, wherein the machine learning model is a neural network, wherein the logic is configured to:
train the neural network using labeled training data;
copy at least some of the layers in the trained neural network to the edge compute location, wherein the layers in the trained neural network copied to the edge compute location include at least the first subset of layers; and
adjust a number of the trained neural network layers that have been copied to the edge compute location based at least in part on a predicted workload.
